(19) United States
(12) Patent Application Publication
(10) Pub. No.: US 2009/0096997 A1
(43) Pub. Date: Apr. 16, 2009

(54) Optical Seaming Adjuster

(76) Inventors: Mark Alan Schultz, Carmel, IN (US); Matthew Robert Lamb, Westfield, IN (US)

Correspondence Address: Robert D. Shedd;Thomson Licensing LLC, PO Box 5312, PRINCETON, NJ, 08543-5312, US

(21) Appl. No.: 12/084,851

(22) PCT Filed: Nov. 9, 2006
(86) PCT No.: PCT/US2006/043867

§ 371 Date: May 9, 2008

Related U.S. Application Data
(60) Provisional application No. 60/734,866, filed on Nov. 9, 2005.

(51) Int. Cl. G03B 21/14; G02B 5/22

(52) U.S. Cl. 353/84; 359/892

(57) ABSTRACT

A structure to adjust optical seaming filters in the z-direction is provided. The adjuster structure uses 5 degrees of freedom to individually adjust a filter on a projector in the z-direction to optimize the projected seam. A set of common identical filters may be used with these adjuster structures and still produce a set of filters that are unique to each projector. The present invention allows the filters to be adjusted in multiple dimensions so the specifications of a particular filter can be relaxed since the adjuster can provide the required unique properties.

### TECHNICAL FIELD

This invention relates a technique for adjusting optical filters for projection systems.

### BACKGROUND ART

Ordering optical filters in a projection system can be difficult since most are very dependent on a specific setup and are unique to a specific projector. Present day implementations generally use x and y axis adjustments to adjust the filter which is normal to the projected light. Many types of seaming applications usually require a unique filter per application.

### BRIEF SUMMARY OF THE INVENTION

The present invention provides a structure to adjust optical seaming filters along the z-direction. The adjuster structure uses 5 degrees of freedom to individually adjust a filter on a projector in the z-direction to optimize the projected seam. A set of common identical filters may be used with these adjuster structures and still produce a set of filters that are unique to each projector. The present invention allows the filters to be adjusted in multiple dimensions so the specifications of a particular filter can be relaxed since the adjuster can provide the required unique properties.

### BRIEF SUMMARY OF THE DRAWINGS

FIG. 1 shows a block diagram of an optical filter adjuster in accordance with the present invention prior to adjustment; and

FIGS. 2-7 show the optical filter adjuster depicted in of FIG. 1 with various different adjustments.

### DETAILED DESCRIPTION

The present invention provides a structure to adjust optical seaming filters in the z-direction. The adjuster structure uses 5 degrees of freedom to individually adjust a filter on a projector in the z-direction to optimize the projected seam. A set of common identical filters may be used with these adjuster structures and still produce a set of filters that are unique to each projector. The present invention allows the filters to be adjusted in multiple dimensions so the specifications of a particular filter can be relaxed since the adjuster can provide the required unique properties.

This adjuster can be used for many type of seaming applications that usually would require a unique filter per application type. The adjuster will adjust almost any type of optical seaming filter, including a straight opaque edge.

Some of the advantages of the present adjuster structure are: 1. Angled sides provide a better transfer efficiency of light so that an anti-reflecting (AR) coating is not required. 2. The adjuster allows very quick and unique alignment on an installation.

Since the eye is very sensitive to edges, the seaming adjustment is very critical. This adjuster can match keystone, gain, and density requirements unique to a projector using a common filter design for all of the projectors.

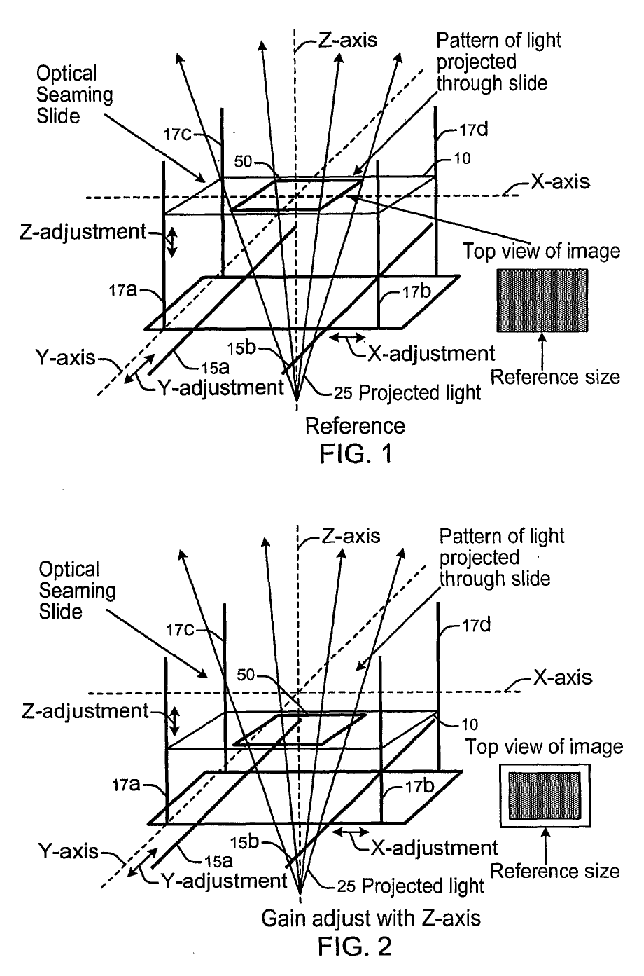

As seen in FIG. 1, the adjuster structure 10 of the present invention is mounted on two rails 15a, 15b that move it in both the x and y directions. This is fairly common for an optical filter. The additional four posts 17 in the vertical direction give the adjuster 10 a range of adjustment which are useful in the alignment of optical seaming filters.

FIG. 1 depicts one embodiment of the present invention. This is an adjuster structure 10 with five degrees of freedom in the z-direction. The adjuster structure includes a floating plate 20. The floating plate 20 is an optical seaming plate that is attached to the vertical posts 17. The floating plate includes a filter 50.

The floating plate 20 may be attached to the vertical posts 17 using any suitable method. Suitable examples include attaching the floating plate 20 to the vertical posts 17 with a ball joint, pivoting joint, or even tied with string. Such methods provide a very flexible joint suited to handle many angles of movement.

The projector light 25 is shown in FIG. 1 as coming from the bottom of this drawing, but it could be sourced from any direction. The projector light 25 may be a set of diverging rays. Using a set of diverging rays provides the ability to size and shape keystones by changing the location where the light makes contact with the filter 50.

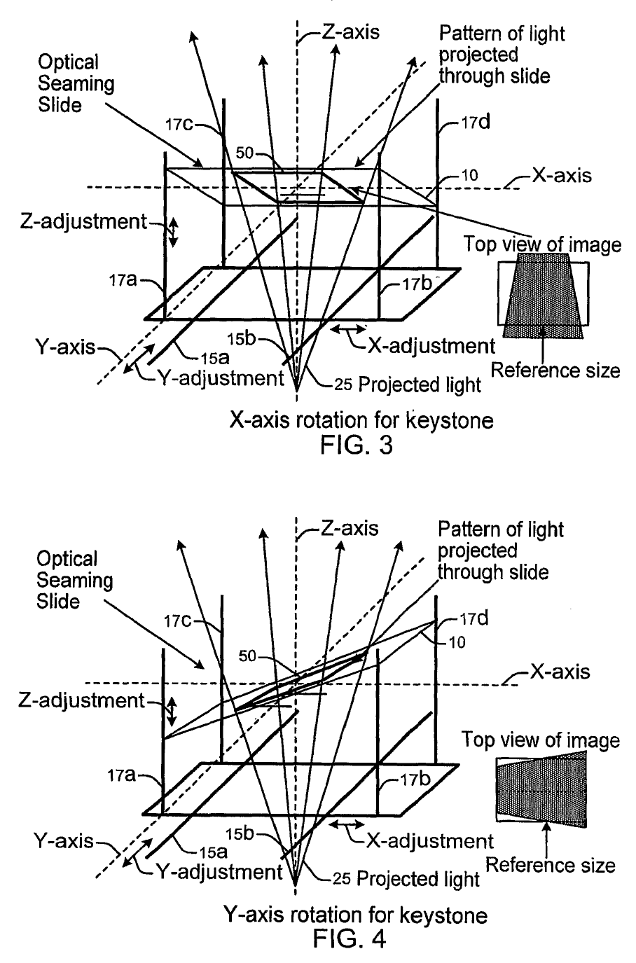

Referring to FIG. 2, there is shown moving the floating plate 20 with the filter 50 up and down along the vertical posts 17. The floating plate 20 is moved in the same direction along each vertical post 17, the same distance. This positioning of the floating plate 20 the same distance, in the same direction along the z-direction reduces the size of the image projected on the screen. This adjustment has the effect of changing the density of the filter 50 since more or less light is being allowed to pass through a given area.

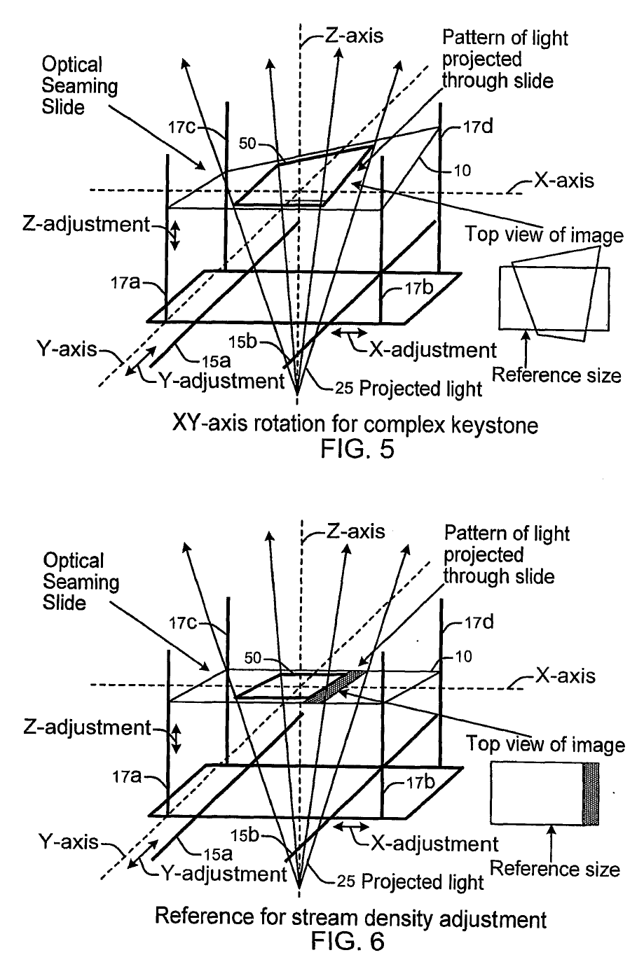

FIGS. 3 and 4 show how the keystones are controlled on either the x or y rotational axis. This is single axis rotation along either the x-axis (FIG. 3) or the y-axis (FIG. 4). In FIG. 3, the floating plate 20 is moved on the same direction for the same distance along two of the vertical posts 17a, 17b. In FIG. 4, the floating plate 20 is moved on the same direction for the same distance along two of the vertical posts 17b, 17d. The position of the floating plate does not move along the other two posts 17a, 17c. These keystone adjustments are very useful to adjust the filter output and compensate for misalignment of mirrors or mountings in other parts of the system. This also allows gradients to be used across a profile since the density of the filter will vary across the keystone.

FIG. 5 shows how a complex figure can be generated using the adjuster structure 10. To adjust this figure in size, the entire adjuster structure 10 is rotated along the x and y axes to shift the adjuster 10 up or down along the posts 17a, 17b, 17c, 17d for a different distance.

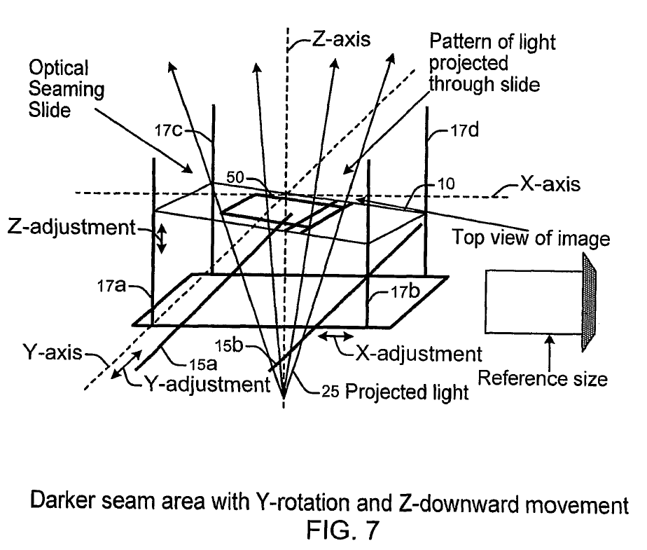

FIG. 6 shows a typical filter with an edge-seaming segment. By using the y-axis rotational adjustment, in this application, the keystone that is found will not enter onto the screen since the projected light is a subset of the slide. Referring to FIG. 7, a keystone adjustment can be used to adjust the density of the filter in the seaming area. By rotating the slide 15a, the width can be adjusted and by moving the adjuster 10 up and down along the slides 17a, 17b, 17c, 17d, the size can be adjusted to help optimize the resulting pictures without using unique custom filters for each projector.

Although an exemplary adjustor for a projection system which incorporates the teachings of the present invention has been shown and described in detail herein, those skilled in the art can readily devise many other varied embodiments that still incorporate these teachings.

1. A projection system, comprising:
a filter coupled to a plate wherein the filter is rotatable along at least one of an x-axis and a y-axis.

2. The projection system of claim 1 wherein the plate is coupled to a plurality of posts.

3. The projection system of claim 2 wherein the plate is coupled to the plurality of posts using one of a ball joint and a pivoting joint.

4. The projection system of claim 1 wherein the filter is further movable along at least one of the x-axis and the y-axis.

5. An optical seaming plate for use in a projection system, comprising:
a filter coupled to a plate wherein the filter is rotatable along at least one of an x-axis and a y-axis.

6. The optical seaming plate of claim 5 wherein the plate is coupled to a plurality of posts.

7. The optical seaming plate of claim 6 wherein the plate is coupled to the plurality of posts using one of a ball joint and a pivoting joint.

8. The optical seaming plate of claim 5 wherein the filter is further movable along at least one of the x-axis and the y-axis.
